(19) United States
(12) Patent Application Publication
(10) Pub. No.: US 2016/0043989 A1
(43) Pub. Date: Feb. 11, 2016

(54) SEARCH ENGINE OPTIMIZATION OF DOMAIN NAMES AND WEBSITES

(71) Applicant: Go Daddy Operating Company, LLC, Scottsdale, AZ (US)

(72) Inventors: Nitin Gupta, Mountain View, CA (US); Raj Nijjer, Phoenix, AZ (US); Tapan Kamdar, San Jose, CA (US)

(21) Appl. No.: 14/453,418

(22) Filed: Aug. 6, 2014

(51) Int. Cl. H04L 29/12; H04L 29/08

(52) U.S. Cl. CPC H04L 61/1511; H04L 67/02

(57) ABSTRACT

The present invention may create a search engine optimized domain name and update a website based on the current domain name, website, forwarding URLs and/or the locations of incoming traffic to the website. The present invention may create a new domain name and a new website based on an initial domain name and an initial website and allow a user to register the new domain name and host the new website with a single purchase. The present invention may also create a new domain name and/or update the language of a website based on the location of incoming traffic to the website. The present invention may also map an IP address/name server to a category of a website and then map the category to one or more top-level domains used in suggested domain names. The present invention may also tokenize a forwarding URL and spin the tokens into additional tokens that may be used to create domain names for registration.

### FIELD OF THE INVENTION

The present invention generally relates to the field of creating search engine optimized (SEO) domain names and updated websites based on the current domain name, current website, forwarding Uniform Resource Locaters (URLs) and/or the location of incoming traffic to the website.

### SUMMARY OF THE INVENTION

The present invention may improve the SEO of websites by recommending SEO optimized domain names and SEO improvements to websites. In one embodiment, an initial domain name may be parsed into a first one or more tokens, where tokens are preferably, but do not have to be, words. An initial website, having an IP address resolvable from the initial domain name, may be scraped for a second one or more tokens and for a content of the initial website. A new domain name may be created based on the tokens from the domain name and/or from the tokens scraped from the initial website. The scraped content from the initial website may be used to fill a template to create a new website. The user may be allowed, preferably triggered by a single purchase from the user, to register the new domain name, host the new website and point the new domain name to the new website.

In another embodiment, a plurality of IP addresses from incoming traffic to an initial website may be logged over a period of time. An initial domain name, having an initial second-level domain and an initial top-level domain, may be registered to a user (operator of the initial website) and point to the initial website. A most common location for the incoming traffic to the website may be determined from the plurality of logged IP addresses. The most common location may be, as non-limiting examples, a city, state, region or country, but is preferably the smallest geographic location possible, while still representing as much of the incoming traffic as possible. A text that represents the most common location (such as NYC for New York, N.Y.) may be combined with one or more tokens/words in the initial second-level domain to create a new domain name that, if available, may be registered by a user, i.e., the domain name registrant.

In another embodiment, a text that represents the most common location (or one of the more common locations) may be determined that is also a valid top-level domain. One or more tokens/words in the initial domain name may be combined with or replaced by the text to create a new domain name having a top-level domain that represents the source of the incoming traffic. The new domain name, if available, may be registered to the user.

In another embodiment, a most common language spoken in the most common location (or one of the more common locations) for the incoming traffic to the initial website may be determined. The language used to write the content of the initial website may also be determined. If the languages are different, then a recommendation may be presented to the user (website operator) to rewrite the content or add content in the most common language.

In another embodiment, the language of the initial website may be automatically translated into the language spoken in the most common location for the incoming traffic and the user may be given the option to replace the initial website (written in the initial language) with a new website (written in the translated language) or to add another website, i.e., the new website so that the user may have two websites written in different languages. IP addresses (which provide the location of the incoming traffic) may be used to select which website is provided.

In another embodiment, an IP address or a name server for an initial domain name that points to a website operated by a user may be determined. The IP address or name server may be mapped to one or more categories that describe the website. As a possible example, the IP address for the website may map to the website category of blog. The category of the website may then be mapped to a new top-level domain. In this example, the category of blog may map to a top-level domain of .blog. A new domain name may be created using the initial second-level domain from the initial domain name (or one or more tokens from the initial second-level domain) combined with the new top-level domain. The new domain name, if available, may be offered, and if selected, registered to the user.

In another embodiment, a domain name may be forwarded to a URL. The URL may be parsed into one or more tokens. The one or more tokens from the URL may be spun (synonyms, frequently co-occurring, antonyms and other related word may be found) to produce a plurality of tokens. One or more valid top-level domains may be matched (either an exact character match and/or noting a relationship or association) to one or more of the plurality of tokens. One or more new domain names may be created based on the second-level domain (or one or more tokens from the second-level domain) of the initial domain name and the matched one or more top-level domains. The new domain names, if available, may be offered, and if selected, registered to the user.

The above features and advantages of the present invention will be better understood from the following detailed description taken in conjunction with the accompanying drawings.

### BRIEF DESCRIPTION OF THE DRAWINGS

FIG. 1 is a block diagram of a system that may be used to practice the present invention.

FIG. 2 is a flow diagram illustrating an example embodiment of the present invention for registering a new domain name and hosting a new website based on an initial domain name and the content of an initial website.

FIG. 3 is a flow diagram illustrating an example embodiment of the present invention for creating a domain name based on traffic to a website and then, if available and selected by the user, registering the domain name.

FIG. 4 is a flow diagram illustrating example additional steps that may be performed after the process illustrated in FIG. 3 or FIG. 8.

FIG. 5 is a flow diagram illustrating example additional steps that may be performed after the process illustrated in FIGS. 3 and 8.

FIG. 6 is a flow diagram illustrating example additional steps that may be performed after the process illustrated in FIGS. 3 and 8.

FIG. 7 is a flow diagram illustrating example additional steps that may be performed after the process illustrated in FIGS. 3 and 8.

FIG. 8 is a flow diagram illustrating an example embodiment of the present invention for creating a new domain name by replacing a top-level domain on an initial domain name with a new top-level domain selected based on the location of incoming traffic to a website.

FIG. 9 is a flow diagram illustrating an example embodiment of the present invention for mapping an IP address or name server to a category of a website, mapping the category of the website to a top-level domain and then registering a domain name comprising the top-level domain to a user.

FIG. 10 is a flow diagram illustrating an example embodiment of the present invention with example additional steps that may be performed after the process illustrated in FIG. 9.

FIG. 11 is a flow diagram illustrating an example embodiment of the present invention for creating a new domain name with an initial second-level domain (from a different domain name) and a new top-level domain based on a forwarding URL.

FIG. 12 is a flow diagram illustrating an example additional step that may be performed after the process illustrated in FIG. 11.

FIG. 13 is a flow diagram illustrating example additional steps that may be performed after the process illustrated in FIG. 11.

FIG. 14 is a flow diagram illustrating an example embodiment of the present invention for creating a new domain name with an initial second-level domain and a new top-level domain based on a URL.

FIG. 15 is a flow diagram illustrating an example embodiment of the present invention for creating a new domain name based on a URL.

FIG. 16 is a flow diagram illustrating example additional steps that may be performed after the process illustrated in FIG. 15.

FIG. 17 is a flow diagram illustrating example additional steps that may be performed after the process illustrated in FIG. 15.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

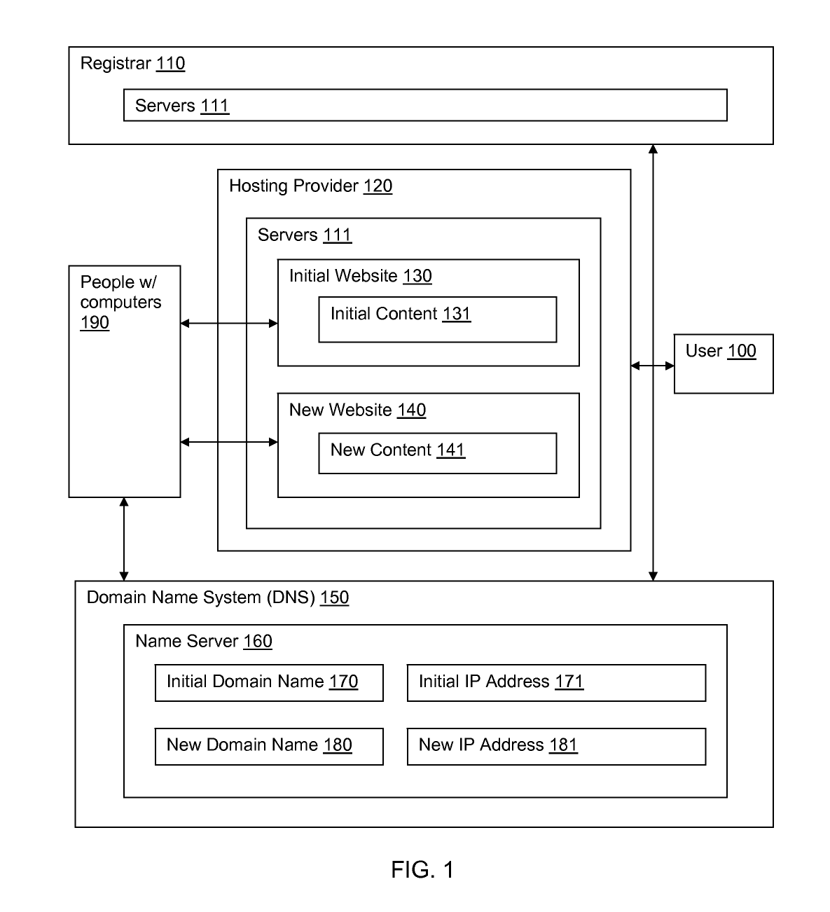

FIG. 1 is a block diagram of a system that may be used to practice the present invention. The arrows may represent computer networks and boxes within boxes may also communicate with each other by computer networks. A computer network is a collection of links and nodes (e.g., multiple computers and/or other devices connected together) arranged so that information may be passed from one part of the computer network to another over multiple links and through various nodes. Non-limiting examples of computer networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow for the easy and robust exchange of information between people with computers 190 and/or websites 130, 140. While only one person with a computer 190 is shown in FIG. 1, hundreds of millions of people 190 around the world have access to computers connected to the Internet via Internet Service Providers (ISPs). Content providers place content 131, 141, such as multimedia information (e.g., text, graphics, audio, video, animation, and other forms of data) at specific locations on the Internet referred to as websites 130, 140. The combination of all the websites and their corresponding web pages on the Internet is generally known as the World Wide Web (WWW) or simply the Web.

For individuals and businesses alike, the Internet continues to be increasingly valuable. People 190 use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are websites 130, 140 that may offer and sell goods and services to individuals and organizations or provide information. Websites 130, 140 may consist of a single webpage, but typically consist of multiple interconnected and related webpages. Websites 130, 140, unless very large and complex or have unusual traffic demands, may reside on a single server 111 and are prepared, maintained and/or operated by a single individual or entity (although websites 130, 140 residing on multiple servers 111 are also common). Menus, links, tabs, etc. may be used by people 190 to move between different web pages within a website 130, 140 or to move to a different website 130, 140.

Websites 130, 140 may be created using HyperText Markup Language (HTML) to generate a standard set of tags that define how the webpages for the website 130, 140 are to be displayed. People 190 using the Internet may access content providers' websites 130, 140 using software known as an Internet browser, such as MICROSOFT INTERNET EXPLORER, GOOGLE CHROME or MOZILLA FIREFOX. After the browser has located the desired webpage, the browser requests and receives information from the webpage, typically in the form of an HTML document, and then displays the webpage content 131, 141 for the person 190 accessing the Internet. The people 190 may view other webpages at the same website 130, 140 or move to an entirely different website using their browser.

While only one user 100 is shown in FIG. 1, the present invention may be practiced with any number of users 100. The user 100 may be a domain name registrant and/or an operator/owner of a website 130, 140. Some users 100, typically those that are larger and more sophisticated, may provide their own hardware, software, and connections to host the users' website(s) 130, 140 on the Internet. But many users 100 either do not have the resources available or do not want to create and maintain the infrastructure necessary to host their own websites 130, 140. To assist such individuals (or entities), hosting providers 120 exist that offer website hosting services. These hosting providers 120 may provide the hardware, software, and electronic communication means necessary to connect multiple websites 130, 140 to the Internet. A single hosting provider 120 may literally host thousands of websites 130, 140 on one or more servers 111. The server 111 may be, as a non-limiting example, one or more Dell PowerEdge(s) rack server(s), HP Blade Servers, IBM Rack or Tower servers, although other types of servers and/or combinations of one or more servers may also be used.

Browsers are able to locate specific websites 130, 140 because each website 130, 140, resource and computer on the Internet has a unique Internet Protocol (IP) address 171, 181. The browser (operated by a person 190) may use the Domain Name System (DNS) to obtain the IP address 171, 181 of a domain name 170, 180 or a URL. As an example, the browser may contact the DNS with an initial domain name 170 or URL and the DNS may allow the name server 160 to respond with an initial IP address 171 associated with the initial domain name 170. In this way browsers are able to find IP addresses 171, 181 for domain names 170, 180 and URLs.

The DNS 150 is a hierarchical distributed naming system for computers, services, or any resource connected to the Internet or a private network. The DNS 150 associates various information with domain names 170, 180 and URLs. Most prominently, the DNS 150 translates easily memorized domain names 170, 180 to the numerical IP addresses 171, 181 needed for the purpose of locating computer services and devices worldwide on the Internet.

The DNS 150 distributes the responsibility of assigning domain names 170, 180 and mapping those domain names 170, 180 to IP addresses 171, 181 by designating authoritative name servers 160 for each domain. Authoritative name servers 160 are assigned to be responsible for their supported domains, and may delegate authority over subdomains to other name servers. This mechanism provides distributed and fault tolerant service and was designed to avoid the need for a single central database.

Only one name server 160 is shown in FIG. 1, but in practice any number of name servers may be used. Name servers 160 may be thought of as acting like telephone books, i.e., name servers 160 translate domain names 170, 180 into IP addresses 171, 181 much like a telephone book can translate a name into a telephone number.

Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses 171, 181, however, even in human readable notation, are difficult for people to remember and use. A URL is much easier to remember and may be used to point to any computer, directory, or file on the Internet. A browser is able to access a website 130, 140 on the Internet through the use of a URL. The URL may include a Hypertext Transfer Protocol (HTTP) request combined with the website's 130, 140 Internet address, also known as the website's domain name 170, 180. An example of a URL with a HTTP request and domain name is: http://www.companyname.com. In this example, the “http” identifies the URL as a HTTP request and the “companyname.com” is the domain name. The “companyname” portion may be referred to as a second-level domain and the “.com” may be referred to as a top-level domain.

Domain names 170, 180 are much easier to remember and use than their corresponding IP addresses 171, 181. The Internet Corporation for Assigned Names and Numbers (ICANN) approves some Generic Top-Level Domains (gTLD) and delegates the responsibility to a particular organization (a “registry”) for maintaining an authoritative source for the registered domain names 170, 180 within a TLD and their corresponding IP addresses 171, 181. For certain TLDs (e.g., .biz, .info, .name, and .org) the Registry is also the authoritative source for contact information related to the domain name and is referred to as a “thick” Registry. For other TLDs (e.g., .com and .net) only the domain name, registrar identification, and name server information are stored within the Registry, and a Registrar 110 is the authoritative source for the contact information related to the domain name 170, 180. Such Registries are referred to as “thin” registries. Most gTLDs are organized through a central domain name Shared Registration System (SRS) based on their TLD.

The process for registering a domain name with .com, .net, .org, and some other TLDs allows a user 100 to use an ICANN-accredited Registrar 110 to register a domain name 170, 180. The Registrar 110 may use a plurality of servers 111 to perform its functions. If a user 100, John Doe, wishes to register the domain name mycompany.com, John Doe may initially determine whether the desired domain name is available by contacting a domain name registrar 110. The user 100 may make this contact using the Registrar's webpage and typing the desired domain name into a field on the registrar's webpage created for this purpose. Upon receiving the request from the user 100, the Registrar 110 may ascertain whether mycompany.com has already been registered by checking the SRS database associated with the TLD of the domain name, by checking with the Registry or by any other now known or later developed method. The results of the search may then be displayed on the webpage to thereby notify the user 100 of the availability of the domain name. If the domain name is available, the user 100 may proceed with the registration process. If the domain name is not available for registration, the user 100 may keep selecting alternative domain names until an available domain name is found. A user 100 that registers a domain name 170, 180 is known as the registrant of the domain name 170, 180. A single entity may be both a Registrar 110 and a hosting provider 120 or the functionality may be spread across two or more entities.

Create a New DN and Website Based on an Initial DN and Website

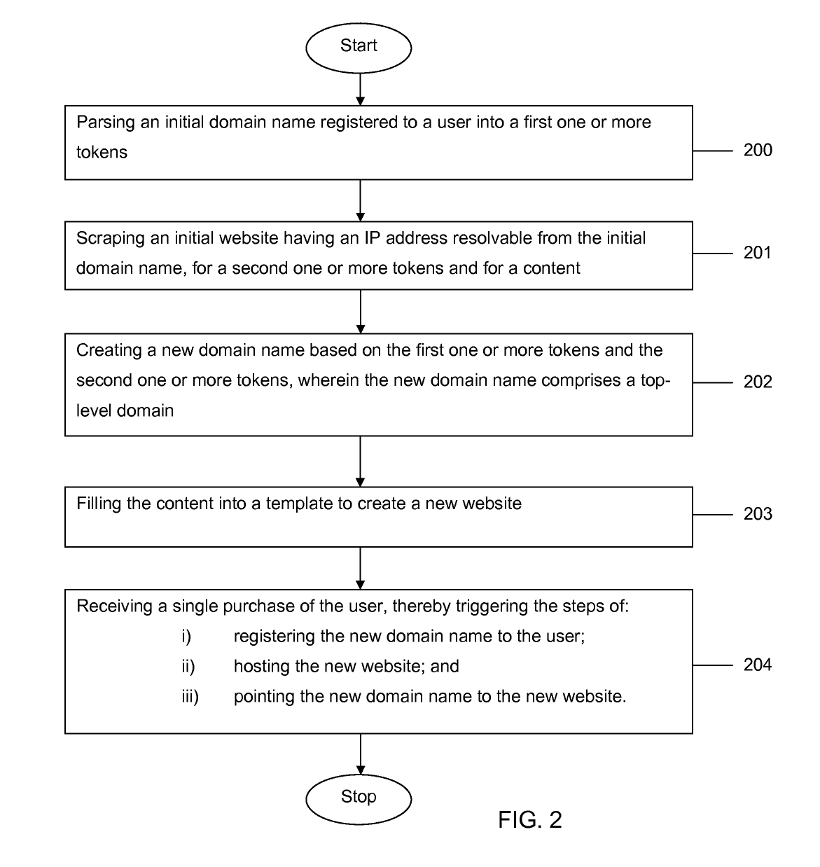

FIG. 2 illustrates a possible embodiment of the present invention. In this embodiment one or more servers 111 may parse an initial domain name 170, registered to a user 100, into a first one or more tokens. (Step 200) The parsing preferably breaks the initial domain name 170 into one or more words which may be referred to as tokens. The parsing may analyze different possible token combinations and attempt to determine which combination of one or more tokens most likely represents the user's 100 intended meaning for the initial domain name 170. As an example, if the initial domain name 170 is “barberlounge.com,” the first one or more tokens may be “barber,” “lounge,” and “.com”.

The one or more servers 111 may scrape an initial website 130, having an IP address 171 resolvable from the initial domain name 170, for a second one or more tokens and for a content 131. (Step 201) Scraping (web harvesting or web data extraction) is a computer software technique to extract or collect content (information) 131, 141 from websites 130, 140. Such software programs may simulate human exploration of the World Wide Web by either implementing low-level Hypertext Transfer Protocol (HTTP), or embedding a fully-fledged web browser, such as Internet Explorer, Google Chrome or Mozilla Firefox.

A new domain name 180 may be created based on the first one or more tokens in the initial domain name 170 and the second one or more tokens from the initial content 131, combined with a valid top-level domain. (Step 202) A valid top-level domain means a top-level domain that may be registered by a Registrar 110 and accepted for use on the Internet.

A template may be filled with the content 131 from the initial website 130 to create a new website 140 with new content 141. (Step 203) The user 100 may be offered via a website an opportunity to register the new domain name and host the new website, preferably with a single purchase.

Upon receiving the single purchase from the user 100, the one or more servers 111 may register the new domain name 180 to the user 100, host the new website 140 with a hosting provider 120 and point the new domain name 180 to the new website 140 in the DNS 150. (Step 204)

The initial domain name 170 and the new domain name 180 may simultaneously point to the new website 140. This would allow people 190 to access the new website 140 using either the initial domain name 170 or the new domain name 180.

The top-level domain for the new domain name 180 may be selected based on the first one or more tokens and/or the second one or more tokens. As an example, if one of the tokens is “blog,” found in either the initial domain name 131 or the initial content 131 of the initial website 130, then a top-level domain name of “.blog” may be used to create the new domain name 180.

The template may be selected from a plurality of templates based on the first one or more tokens from the initial domain name 170 or the second one or more tokens from the initial website 130. Templates may have a prearranged design or layout for the appearance of the new website 140. Each template may have a unique design designating where images, text, data entry fields, menus, borders, social media links, etc. are to be located. A template may allow for one or more images to be placed in predetermined image locations and text to be placed in predetermined text locations on a the new website 140. Templates may be general purpose or be designed for a particular type or category of website 130, 140, such as personal, restaurant, provider of online goods and/or services, informational, social media, etc.

Create a New DN Based on Incoming Traffic Location

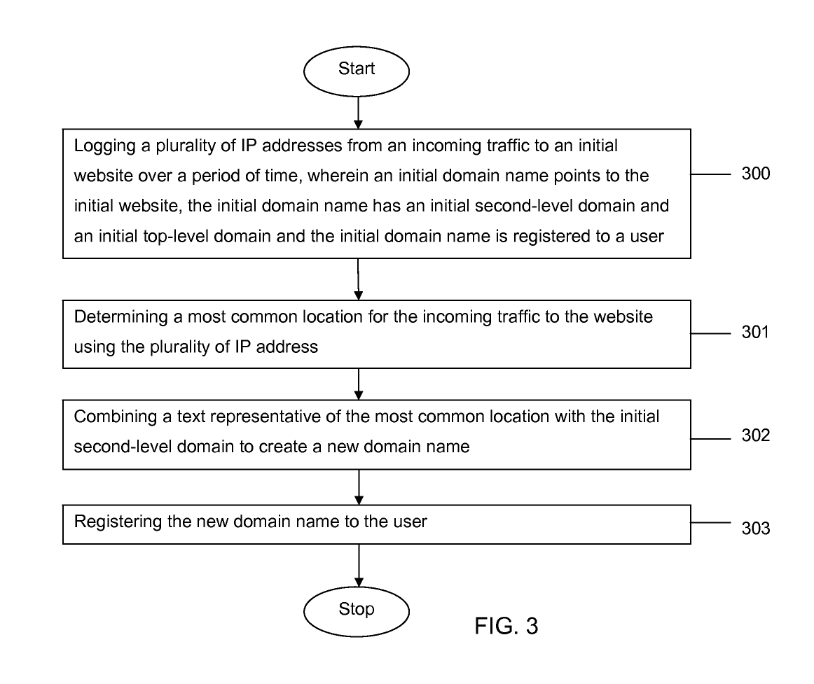

FIG. 3 illustrates a possible embodiment of the present invention. The IP addresses of incoming traffic to an initial website 130 may be logged, i.e., stored, over a period of time. An initial domain name 170, having an initial second-level domain and an initial top-level domain may be registered to a user 100 and point to the initial website 130. (Step 300)

A most common location for the incoming traffic to the website 130 may be determined using the logged IP addresses. (Step 301) The locations where IP addresses have been assigned is publicly known, allowing for the location of the IP address in the incoming traffic to be determined. As an example, if a majority or a plurality (the most common) of the incoming traffic's IP addresses are from Phoenix, Ariz., then a location of Phoenix may be determine. If the incoming traffic's IP addresses are spread throughout the state of Arizona, then a location of Arizona may be determined. In preferred embodiments, the smallest possible geographical region that still captures the majority or plurality of incoming traffic may be selected. In other embodiments, additional locations that are also common in the incoming traffic may also be determined.

A text representing the most common location (or a common location) may be combined with the initial second-level domain to create a new domain name. (Step 302) Combined may mean the text representing the most common location may be added to, or replace other text/tokens/words/characters in the initial second-level domain and other text/tokens/words/characters in the initial second-level domain may be eliminated. As examples, if the initial domain name 130 is barberlounge.com and the most common location is determined to be Phoenix, then new domain names 180 of Phoenixbarberlounge.com, Barberphoenixlounge.com, Barberloungephoenix.com, Barberphoenix.com, Phoenixbarber.com, Loungephoenix.com and Phoenixlounge.com, as non-limiting examples, may be created.

The availability of one or more of these created domain names may be determined as previously described. The created domain names that are available may be offered to the user 100 for registration. If the user 100 selects one or more of these created domain names that are available, the domain names 180 may be registered to the user 100. (Step 303)

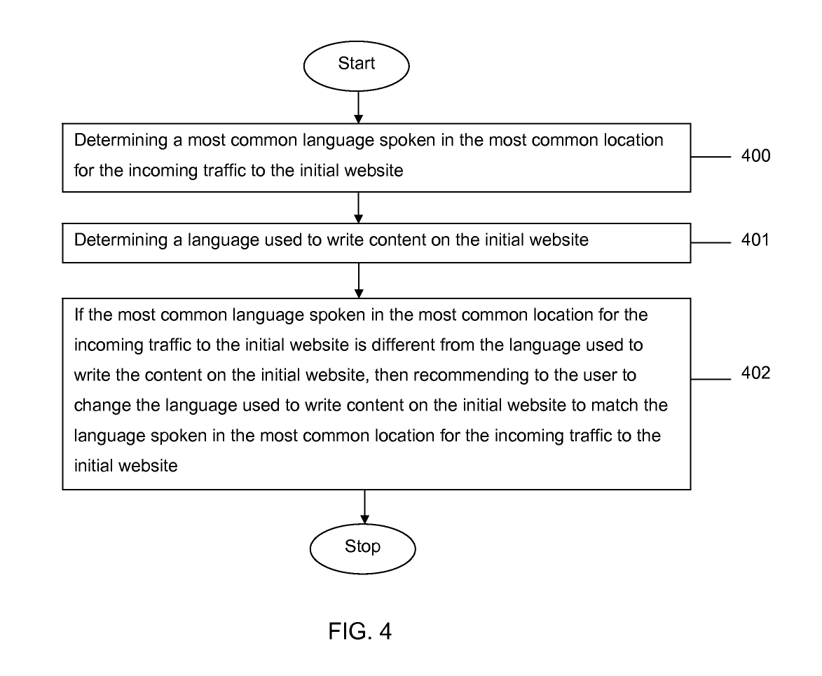

FIG. 4 illustrates a possible embodiment of the present invention. These steps may be performed after the process illustrated in FIG. 3. A most common language spoken in the most common location for the incoming traffic to the initial website 130 may be determined. (Step 400) As an example, if the most common location for the incoming traffic is determined to be Phoenix, Ariz., then the English language may be determined to be the most common language spoken.

The language used to write the initial content 131 on the initial website 130 may also be determined by, as a non-limiting example, comparing text within the initial content 131 with electronic dictionaries of various languages. (Step 401)

If the most common language spoken in the most common location for the incoming traffic to the initial website 130 is different from the language used to write the initial content 131, then it may be recommended to the user 100 to change the language used to write initial content 131 or add additional content to match the language spoken in the most common location for the incoming traffic to the initial website. (Step 402)

As examples of other embodiments, it may also be determined that the Spanish language is the second most common language spoken in the most common location (Phoenix, Ariz.) and/or that the Spanish language is the most common language in a determined second most common location. In other embodiments, the percentage (or other statistical analysis) of different languages in the incoming traffic to the initial website 130 may be calculated. The languages that form a significant percentage of the incoming traffic to the initial website 130 (or all the language with their given percentages and/or ranks) may be communicated to the user 100 as information or as a recommendation to create content and/or one or more websites in these other languages. The higher the percentage or rank a language is for the incoming traffic, the greater the benefit to create content or additional websites using this language.

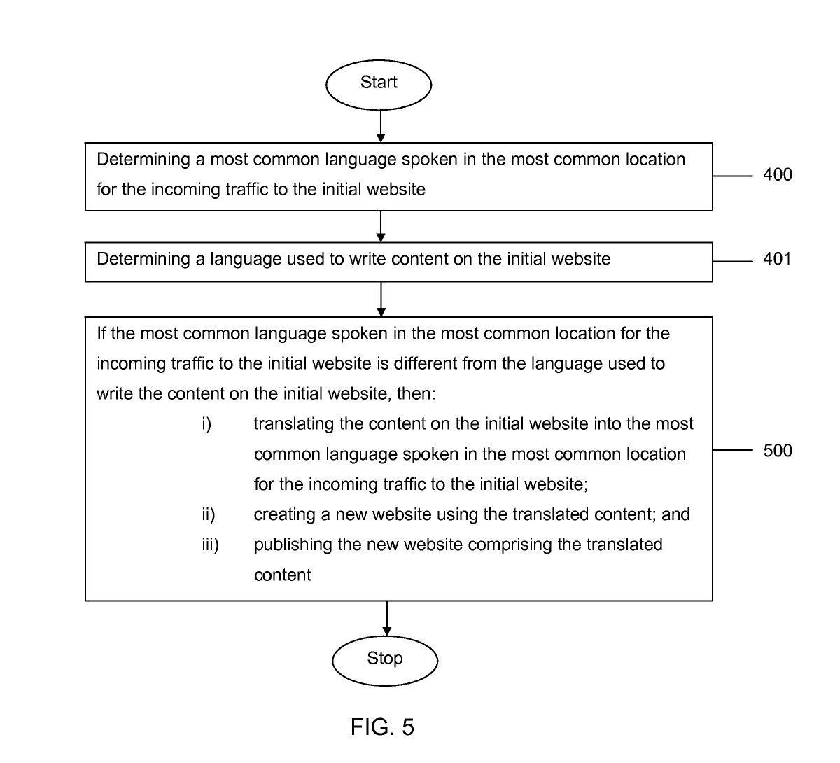

FIG. 5 illustrates a possible embodiment of the present invention. As in the previous embodiment in FIG. 4, a most common language spoken in the most common location for the incoming traffic to the initial website 130 and the language used to write the initial content 131 may be determined. As an example, it may be determined that most of the incoming traffic, as an example, Mexico City, Mexico, likely speaks Spanish while the initial website 130 content may be, as an example, in the English Language.

If the most common language spoken (Spanish in this example) in the most common location (Mexico City, Mexico) for the incoming traffic to the initial website 130 is different from the language (English language in this example) used to write the content on the initial website, then the initial content 131 in English may be translated into Spanish. A new website 140 may be created using the translated content (new content 141) and the new website 140 may then be publishing with the translated content. (Step 500) In other embodiments, both websites 130, 140 may remain available, depending on the IP address of the incoming traffic. Thus, IP addresses from Spanish speaking locations may be provided a website in Spanish, while IP address from English speaking locations may be provided a website in English.

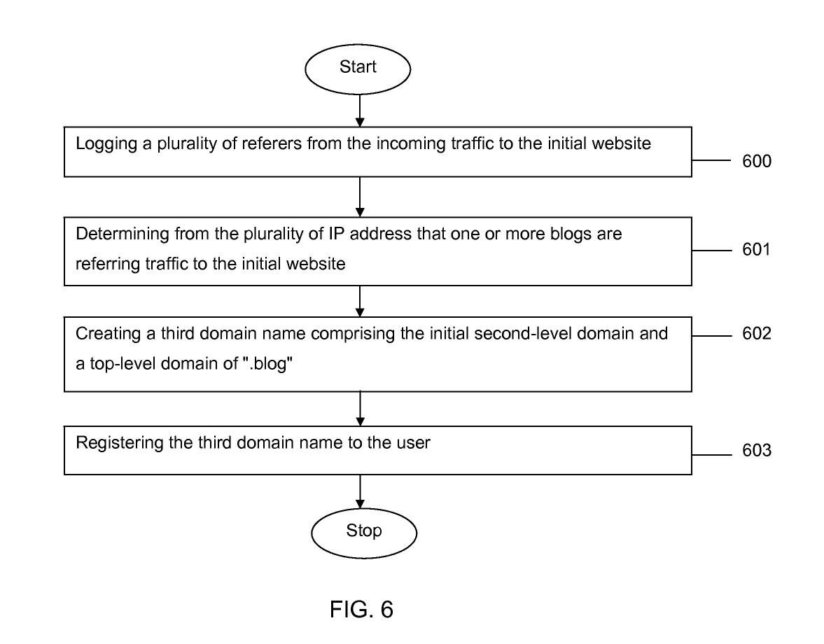

FIG. 6 illustrates a possible embodiment of the present invention. In this embodiment, referels from other websites may be logged as part of the incoming traffic to the website 130. (Step 600) The referel logging may be used to determine if one or more blogs are referring traffic to the initial website 130 and the percentage of incoming traffic from these referral blogs. (Step 601) If the number or percentage of incoming traffic from blog referels exceeds some predetermined threshold, then a new domain name 180 may be created that includes a top-level domain of “.blog”. (Step 602) If this new domain name 180 is determined to be available, it may be offered, and if selected, registered to the user 100. (Step 603)

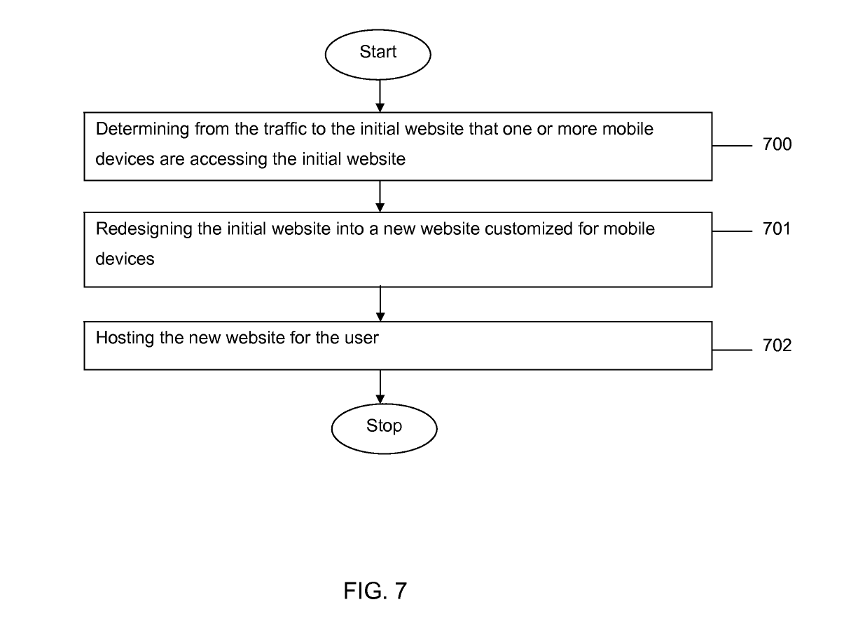

FIG. 7 illustrates a possible embodiment of the present invention. In this embodiment the traffic to the initial website 130 may be analyzed to determine whether one or more mobile devices are accessing the initial website 130 and what percentage of traffic is coming from mobile devices. (Step 700) If the number or percentage of traffic from mobile devices exceeds a predetermined threshold, then a recommendation may be sent to the user 100 to redesign the initial website 130 or the initial website 130 may be programmatically altered to create a new website 140. (Step 701)

Websites 130, 140 may be redesigned for mobile devices using any method. One method to redesign the website 130 for mobile devices is to reduce the number of columns (width) and to reposition columns over each other (vertical stacking of columns) which may increase the length of a webpage. The new website 140 may then be hosted for the user 100. (Step 702)

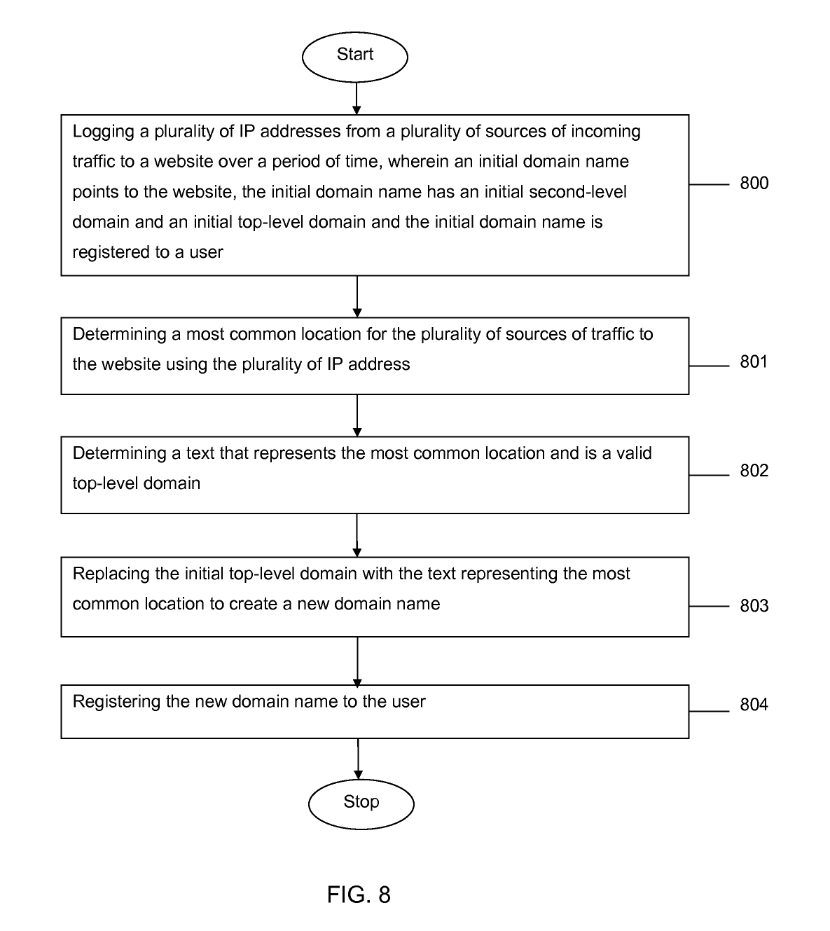

FIG. 8 illustrates a possible embodiment of the present invention. In this embodiment, a plurality of IP addresses from a plurality of sources of incoming traffic to an initial website 130 may be logged or stored over a period of time for analysis. The initial domain name 170 may point, via the DNS 150, to an initial website 130 at an initial IP address 171. The initial domain name 170 may be registered to a user 100 and have an initial second-level domain and an initial top-level domain. (Step 800)

A most common location for the plurality of sources of traffic to the initial website 130 may be determined using the plurality of IP address. (Step 801) In other embodiments, a plurality of common locations for the plurality of sources of traffic to the initial website 130 may be determined. A text may be determined that both represents the most common location (or at least one of the more common locations) and is also a valid top-level domain. (Step 802) An example would be if Arizona was the most common, or at least one of the more common, locations of the sources of traffic to the initial website 130 and if .arizona was also a valid top-level domain, then the determined text may be .arizona.

The initial top-level domain may be replaced with the text representing the most common location that is also a valid top-level domain. (Step 803) Continuing with the previous example, if the initial domain name was barberlounge.com, then the text, i.e., “.arizona” may replace the initial top-level domain, i.e., “.com,” thereby creating the new domain name 180 of barberlounge.arizona. The availability of barberlounge.arizona may be checked, and if available, the new domain name of barberlounge.arizona may be offered to the user 100 for registration. If the user 100 selects to register barberlounge.arizona, the new domain name 180 may be registered to the user 100. (Step 804)

Mapping Locations and Categories of Websites to Create Domain Names

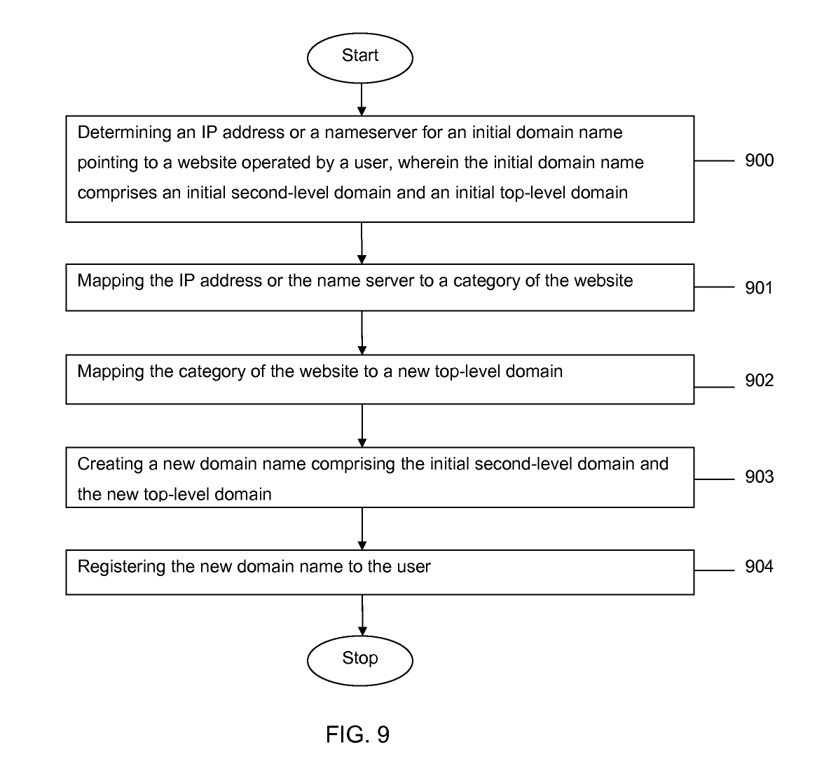

FIG. 9 illustrates a possible embodiment of the present invention. An IP address 171 or a name server may be determined for an initial domain name 170 pointing to a website 130. The website 130 may be operated by a user 100. The initial domain name 170 may comprise an initial second-level domain and an initial top-level domain. (Step 900) As an example, if the initial domain name 170 is Hellocats.com, Hellocats is the initial second-level domain and .com is the initial top-level domain.

The IP address 171 or the name server may be mapped to a category of the website 130. (Step 901) As an example, the domain name Hellocats.com may point to the IP address 171 of 66.155.11.238 as stored in the DNS 150. The IP address 171 of 66.155.11.238 may be mapped to determine that it falls in the category of Wordpress. This may be accomplished because the category(ies) of many IP addresses are already known. In practice any number of different categories for the website 130 may be determined from an IP address.

The category(ies) of the website 130 may be mapped to one or more new top-level domains. (Step 902) Continuing with the previous example, the category Wordpress may map to words like Blog, Journal and Site. Since .Blog is the only valid top-level domain, the website may be mapped to the new top-level domain of .Blog. In other embodiments, the mapping may be designed to limit the mapping to only valid top-level domains so only .Blog (and not .Journal and .Site) would be considered. Also, it may be possible to determine a plurality of valid top-level domains for the one or more categories mapped to the website 130.

A new domain name 180 may be created from the initial second-level domain and the new top-level domain. (Step 903) In the running example, the initial second-level domain is Hellocats and the new top-level domain is Blog. Thus, the new domain name 180 Hellocats.Blog may be created in this manner. In other embodiments, the initial second-level domain may be broken into tokens/words and one or more of these tokens/words may be combined with each other and with the new top-level domain to create other new domain names 180.

The availability of the new domain name 180 (in practice, one or more new domain names 180 may be created) may be checked via a Registry, downloaded zone files, or by any other method now known or later developed in the art. If the new domain name 180 is available, it may be offered to the user 100 for registration. If the user 100 selects the new domain name 180 for registration, the new domain name 180 may be registered to the user 100. (Step 904)

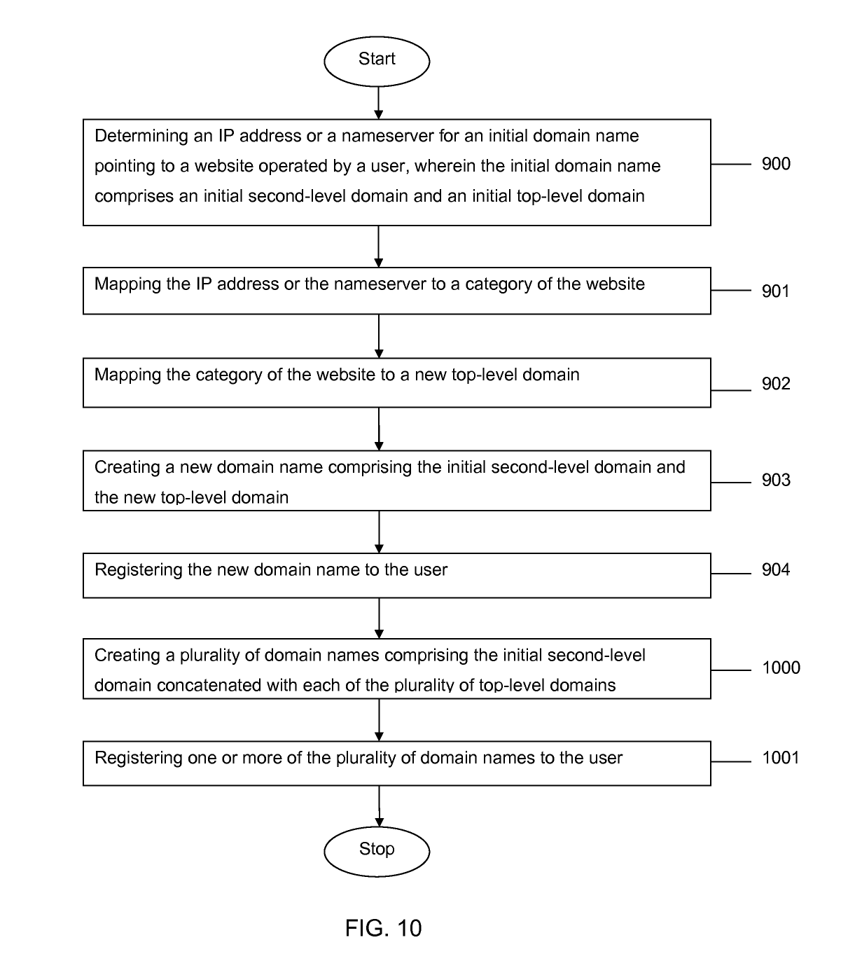

FIG. 10 illustrates a possible embodiment of the present invention. This embodiment may be performed, for example, after the process just described for FIG. 9. In this embodiment, a plurality of new domain names 180 may be created comprising the initial second-level domain and a plurality of valid top-level domains. (Step 1000) Thus, if the initial second-level domain is Hellocats and the plurality of valid top-level domains is .Blog and .NYC, then the new domain names 180 of Hellocats.Blog and Hellowcats.NYC may be created. In other embodiments, the initial second-level domain may be broken into tokens/words and one or more of these tokens/words may be combined with each other and with the new top-level domain to create other new domain names 180.

As before, these new domain names may be checked for availability, if available, offered to the user 100, and if selected by the user 100, one or more of the plurality of new domain names may be registered to the user 100. (Step 1001)

Creating a Domain Name from a Forwarding URL

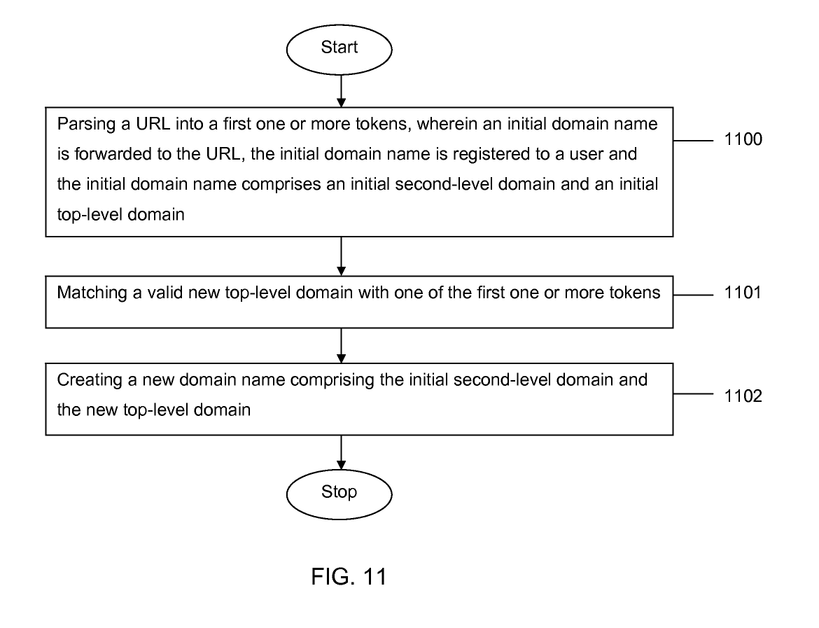

FIG. 11 illustrates a possible embodiment of the present invention. An initial domain name 170, registered to a user 100, may be forwarded to a URL. The URL may be parsed into a first one or more tokens. The initial domain name 170 may have an initial second-level domain and an initial top-level domain. (Step 1100) As an example, the initial domain name may be Hellocats.com, with an initial second-level domain of Hellocats and a top-level domain of .com, and this domain name may be forwarded to the URL facebook.com/NYBlogger. The URL facebook.com/NYBlogger may be parsed into the first one or more tokens facebook, .com, NY and Blogger. In other embodiments, only the path may be tokenized so the one or more tokens would be NY and Blogger.

A valid new top-level domain may be matched with one of the first one or more tokens. (Step 1101) If one of the first one or more tokens is a valid top-level domain, a new domain name 180 may be created that comprises the initial second-level domain and the valid top-level domain. If there are no valid top-level domains that match one of the first one or more tokens, then no new domain names are created. In other embodiments, the initial second-level domain (for example, Hellocats) may be broken into tokens/words (for example, hello and cats) and one or more of these tokens/words may be combined with each other and with the new top-level domain to create other new domain names 180. As an example, the domain name cats.blog may be created.

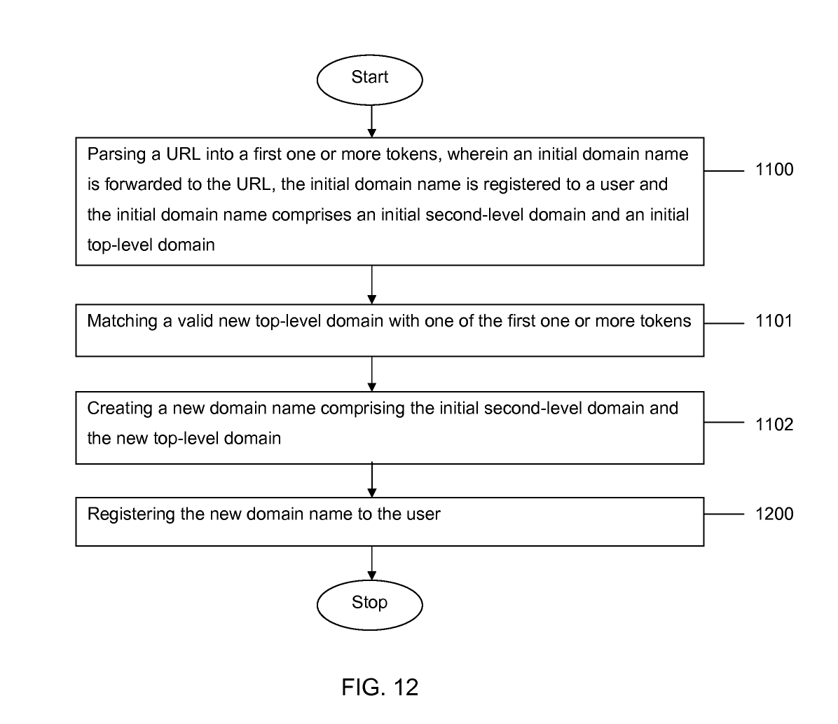

FIG. 12 illustrates a possible embodiment of the present invention. As previously described, the new domain names may be checked for availability, if available, offered to the user 100, and if selected by the user 100, one or more of the selected plurality of new domain names may be registered to the user 100. (Step 1200)

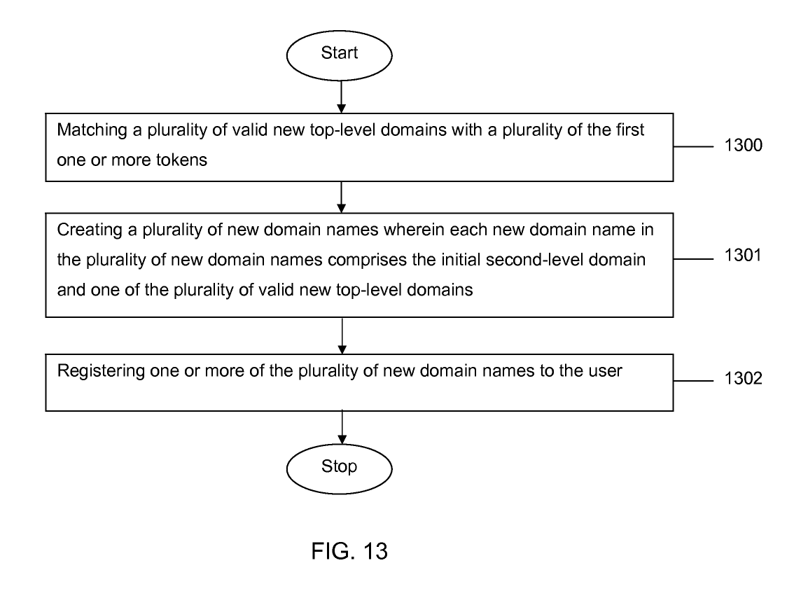

FIG. 13 illustrates an embodiment with additional steps that may be performed after or in combination with the process illustrated in FIG. 11. In this embodiment, a plurality of valid new top-level domains may be matched with a plurality of the first one or more tokens. (Step 1300) A plurality of new domain names may be created by combining the initial second-level domain with one of the plurality of valid new top-level domains. The plurality of new domain names may be checked for availability, if available, offered to the user 100, and if selected by the user 100, one or more of the plurality of new domain names may be registered to the user 100. (Step 1302)

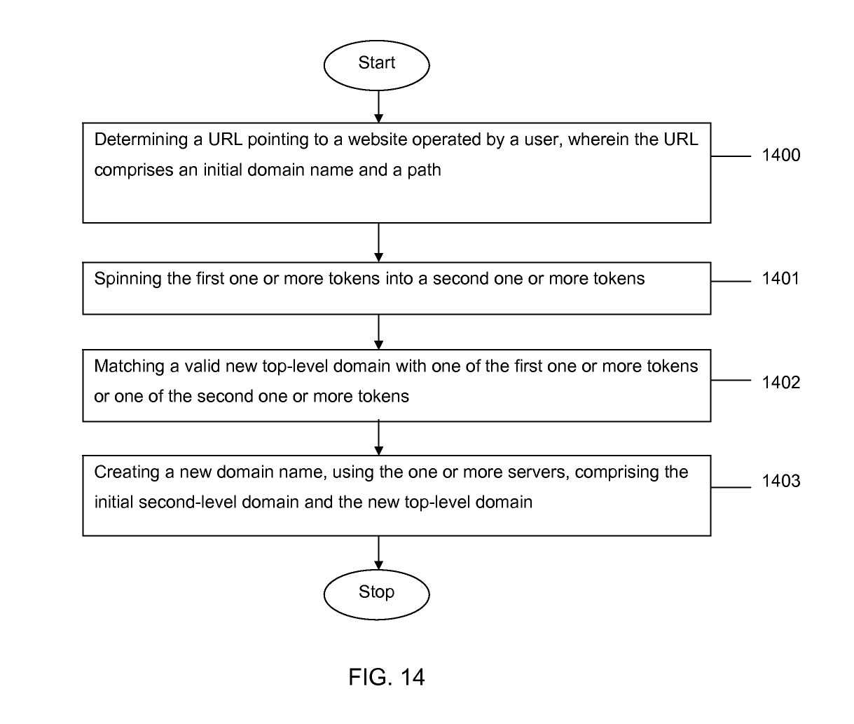

FIG. 14 illustrates a possible embodiment of the present invention. An initial domain name 170, registered to a user 100, may be forwarded to a URL. The URL may be parsed into a first one or more tokens. The initial domain name 170 may have an initial second-level domain and an initial top-level domain. (Step 1400) As an example, the initial domain name may be Hellocats.com, with an initial second-level domain of Hellocats and a top-level domain of .com. The domain name Hellocats.com may be forwarded to the URL facebook.com/NYBlogger. The URL facebook.com/NYBlogger may be parsed into the first one or more tokens facebook, .com, NY and Blogger. In some embodiments, only the path is tokenized so that the one or more tokens would be NY and Blogger. In some embodiments, the initial second-level domain of Hellocats may also be parsed into the tokens hello and cats and included in the first one or more tokens.

The first one or more tokens may be spun into a second one or more tokens. (Step 1401) As an example, the token NY may be spun into NYC and the token Blogger may be spun into the token Blog.

A valid new top-level domain may be matched with one of the first one or more tokens or one of the second one or more tokens. (Step 1402) All matching and spinning steps may be biased, weighted or forced into producing one or more valid top-level domains whenever this might be advantageous for any of the described embodiments. As an example, .NYC and .Blog are valid top-level domains and may be matched with one of the first one or more tokens or with one of the second one or more tokens.

One or more new domain names 180 may be created comprising the initial second-level domain (or one or more tokens from the initial second-level domain) and a valid top-level domain. (Step 1403) Continuing with the example, the initial second-level domain may be Hellocats and the valid top-level domains may be .NYC and .Blog. These may be used to produce a plurality of new domain names 180, specifically, Hellocats.NYC and Hellocats.Blog. The plurality of new domain names 180 may be checked for availability. If the new domain names 180 are available, the new domain names 180 may be offered to the user 100. If the user 100 selects one or more of the offered plurality of new domain names 180, the selected offered new domain names 180 may be registered to the user 100.

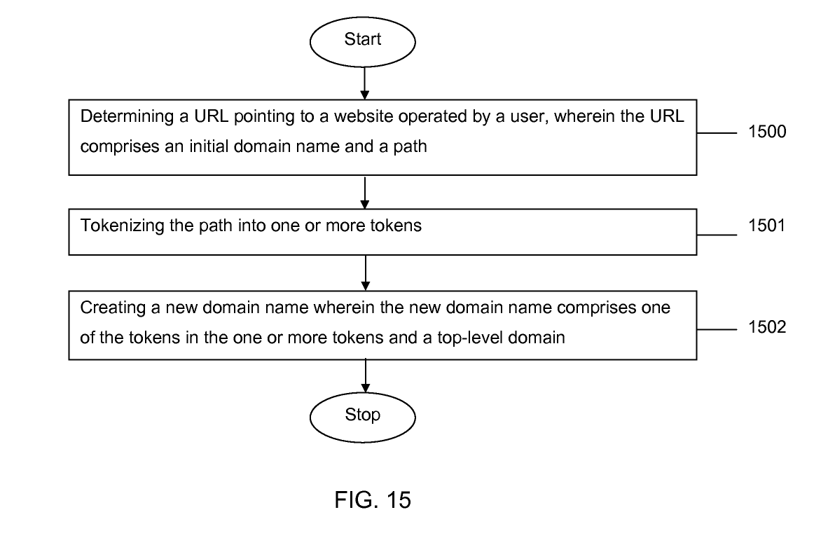

FIG. 15 illustrates a possible embodiment of the present invention. In this embodiment, a URL is identified that points to a website 130 operated by a user 100. The URL may include an initial domain name 170 and a path. (Step 1500) As an example, the URL may be Brooklynbarber.com/discounts which has an initial domain name 170 of Brooklynbarber.com and a path of discounts.

The URL and/or the path may be tokenized into one or more tokens. (Step 1501) As an example, the URL Brooklynbarber.com/discounts may be tokenized into the tokens Brooklyn, barber, .com and discounts.

A new domain name 180 may be created using one of the tokens and a valid top-level domain. (Step 1502) As an example, the new domain name 180 may be Barberdiscounts.com. Barberdiscounts.com uses the token discounts (and the token barber from the URL) and has a valid top-level domain of .com.

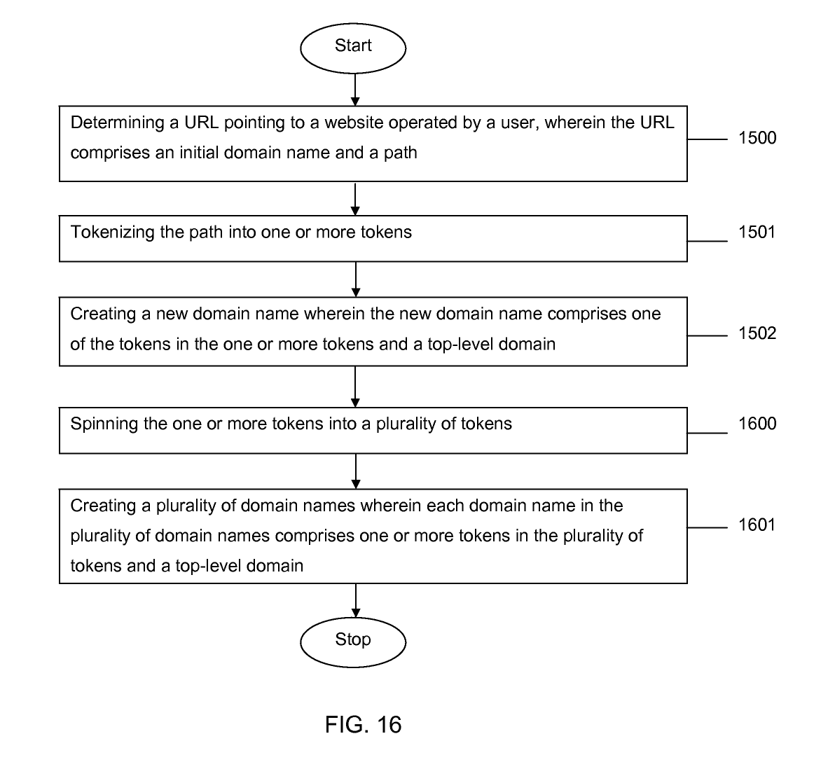

FIG. 16 illustrates additional steps that may be performed after or incorporated into the process illustrated in FIG. 15. In this embodiment, the one or more tokens may be spun into a plurality of tokens. (Step 1600) As an example, the one or more tokens Brooklyn, barber, .com and discounts may be spun into the plurality of tokens newyork, haircut and bargains.

A plurality of domain names may be created by combining one or more of the tokens and the plurality of tokens along with a valid top-level domain. Thus, as just a few of the possible examples, the domain names of Newyorkhaircuts.nyc, Barberdiscounts.com, and haircutbargains.com may be created in this example. (Step 1601)

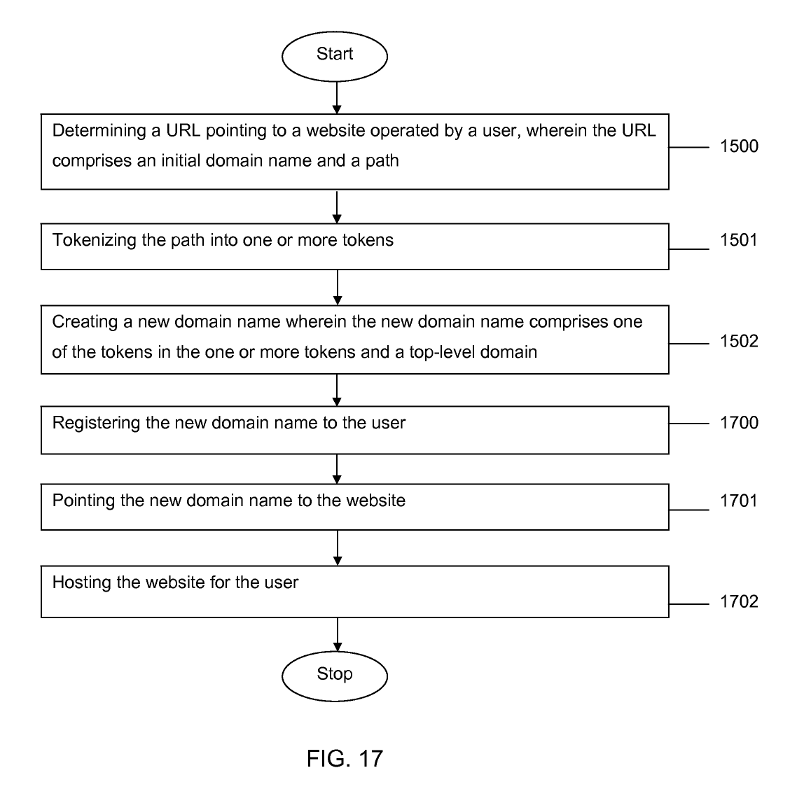

FIG. 17 illustrates additional steps that may be performed after or incorporate into the process illustrated in FIG. 15. In this embodiment, if the domain names 180 are available, the domain names 180 may be offered to the user 100. If the user 100 selects one or more of the offered plurality of domain names 180, the selected offered domain names 180 may be registered to the user 100. (Step 1700)

A new domain name 180 (or multiple registered new domain names) registered to the user 100 may be pointed to the website 130 operated by the user 100. (Step 1701) This may be done automatically for the user 130 immediately after the user 100 registers the new domain name 180 (or multiple new domain names) by updating the name servers 160 in the DNS 150. In other embodiments, the website 130 may be automatically hosted for the user 100. (Step 1702)

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the steps of:
a) determining an IP address or a name server, using one or more servers, for an initial domain name pointing to a website operated by a user, wherein the initial domain name comprises an initial second-level domain and an initial top-level domain;
b) mapping the IP address or the name server, using the one or more servers, to a category of the website;
c) mapping the category of the website, using the one or more servers, to a new top-level domain;
d) creating a new domain name comprising the initial second-level domain and the new top-level domain; and
e) registering the new domain name, using the one or more servers, to the user.

2. The method of claim 1, wherein the IP address or the name server map to a plurality of categories for the website.

3. The method of claim 2, wherein the plurality of categories for the website maps to a plurality of top-level domains.

4. The method of claim 3, further comprising the steps of:
f) creating a plurality of domain names comprising the initial second-level domain concatenated with each of the plurality of top-level domains; and
e) registering one or more of the plurality of domain names to the user.

5. The method of claim 1, wherein the category for the website maps to a plurality of top-level domains.

6. The method of claim 5, further comprising the steps of:
f) creating a plurality of domain names comprising the initial second-level domain concatenated with each of the plurality of top-level domains; and
e) registering one or more of the plurality of domain names to the user.

7. A method, comprising the steps of:
a) parsing a URL, using one or more servers, into a first one or more tokens, wherein an initial domain name is forwarded to the URL, the initial domain name is registered to a user and the initial domain name comprises an initial second-level domain and an initial top-level domain;
b) matching a valid new top-level domain, using the one or more servers, with one of the first one or more tokens; and
c) creating a new domain name, using the one or more servers, comprising the initial second-level domain and the new top-level domain.

8. The method of claim 7, further comprising the step of:
d) registering the new domain name, using the one or more servers, to the user.

9. The method of claim 7, further comprising the steps of:
d) matching a plurality of valid new top-level domains, using the one or more servers, with a plurality of the first one or more tokens;
e) creating a plurality of new domain names, using the one or more servers, wherein each new domain name in the plurality of new domain names comprises the initial second-level domain and one of the plurality of valid new top-level domains; and
f) registering one or more of the plurality of new domain names, using the one or more servers, to the user.

10. A method, comprising the steps of:
a) parsing a URL, using one or more servers, into a first one or more tokens, wherein an initial domain name is forwarded to the URL, the initial domain name is registered to a user and the initial domain name comprises an initial second-level domain and an initial top-level domain;
b) spinning the first one or more tokens, using the one or more servers, into a second one or more tokens;
c) matching a valid new top-level domain, using the one or more servers, with one of the first one or more tokens or one of the second one or more tokens; and
d) creating a new domain name, using the one or more servers, comprising the initial second-level domain and the new top-level domain.

11. The method of claim 10, further comprising the step of:
e) registering the new domain name, using the one or more servers, to the user.

12. The method of claim 10, further comprising the steps of:
e) matching a plurality of valid new top-level domains, using the one or more servers, with one or more of the first one or more tokens and/or one or more of the second one or more tokens;
f) creating a plurality of new domain names, using the one or more servers, wherein each new domain name in the plurality of new domain names comprises the initial second-level domain and one of the plurality of valid new top-level domains; and
g) registering one or more of the plurality of new domain names, using the one or more servers, to the user.

13. A method, comprising the steps of:
a) determining a URL pointing to a website operated by a user, using one or more servers, wherein the URL comprises an initial domain name and a path;
b) tokenizing the path into one or more tokens; and
c) creating a new domain name, using the one or more servers, wherein the new domain name comprises one of the tokens in the one or more tokens and a top-level domain.

14. The method of claim 13, further comprising the steps of:
d) spinning the one or more tokens, using the one or more servers, into a plurality of tokens;
e) creating a plurality of domain names, using the one or more servers, wherein each domain name in the plurality of domain names comprises one or more tokens in the plurality of tokens and a top-level domain.

15. The method of claim 13, further comprising the step of:
d) registering the new domain name, using the one or more servers, to the user.

16. The method of claim 15, further comprising the step of:
e) pointing the new domain name to the website.

17. The method of claim 15, further comprising the step of:
e) hosting the website, on one or more servers, for the user.
